(19) United States
(12) Patent Application Publication
(10) Pub. No.: US 2006/0140144 A1
(43) Pub. Date: Jun. 29, 2006

(54) Method and system for providing an open gateway initiative bundle over the air

(75) Inventors: John D. Bruner, South Barrington, IL (US); Steve R. Bunch, Harvard, IL (US); Samir N. Mehta, Sammamish, WA (US)

Correspondence Address: VEDDER PRICE KAUFMAN & KAMMHOLZ, 222 N. LASALLE STREET, CHICAGO, IL, 60601, US

(73) Assignee: Motorola, Inc., Schaumburg, IL (US)

(21) Appl. No.: 11/024,242

(22) Filed: Dec. 27, 2004

(51) Int. Cl. G06F 7/00

(52) U.S. Cl. 370/328; 370/401

(57) ABSTRACT

A method and apparatus provides an open services gateway initiative (OSGi) bundle over the air to a wireless mobile device by obtaining data representing an OSGi bundle in the form of a JAVA archive (JAR) file (802), such as from a trusted authority, or any other suitable source, and generates, for sending to the wireless mobile device, a MIDlet wrapped OSGi bundle (712) that contains data representing a MIDP JAR file (900) containing the OSGi bundle (902) and a corresponding MIDlet (904) operative to invoke an OSGi bundle provisioning application interface (API) (804) on the wireless mobile device to install said bundle. The method may be carried out for example by a network element, or any other suitable element or elements. In one example, a standard MIDP server sends the MIDlet wrapped OSGi bundle to the wireless mobile device since it is in a suitable MIDP format although it contains an OSGi bundle.

### FIELD OF THE INVENTION

The present invention relates generally to the field of apparatus and methods for providing over the air applets and more particularly to methods and systems for providing open gateway initiative (OSGi) type bundles over the air and for processing received OSGi bundles.

### BACKGROUND OF THE INVENTION

Computing devices and other devices may have different capabilities and features based on the applications installed in their memory. Firmware and applications may be pre-installed to a computing device before purchase by a customer or installed after purchase by a customer or service technician via a storage media, such as a magnetic or optical disk. For computing devices that communicate with a computer network, applications may be installed after a customer or service technician downloads the applications to the computing device.

Wireless mobile devices, such as cell phones, PDA's or any other suitable wireless mobile devices may utilize applications or may be compliant with various standards and may be for example J2ME compliant devices. Such devices have security managers which enforce security policies which are a type of rule or rules to ensure that various security constrains are maintained within the device. One security policy may be that only certain applications supplied by certain authors or sources can invoke an SMS messaging. Numerous other security policies are also known and enforced by the security policy manager. In addition, certain mobile device platforms may use defined specification requests (JSR) which are standard sets of API's defined for a particular mobile device operational platform. One specification for mobile devices is a J2ME compliant device that employs mobile information device profiles (MIDP). MIDlets are applications that run in a MIDP environment. An execution environment uses a defined set of API's that are defined for that particular execution environment. Therefore a MIDP environment is an environment that uses a defined set of JSR's and other API's. Typically, a single device uses a single execution environment. Where a wireless mobile device utilizes two or more execution environments, there may be different security models employed by the different execution environments.

The Open Services Gateway Initiative (OSGi) was initiated to develop an open specification for the delivery of services over local networks and devices. OSGi was developed to provide services to environments such as homes, cars and offices. Devices that employ the OSGi specification include, but are not limited to, television set top boxes, service gateways, cable modems, consumer electronic devices, wireless mobile devices, personal computers (PCs), industrial computers and automobiles. A specification, entitled “The OSGi Services Platform, Release 3,” was published in 2003.

The OSGi environment is organized around a “framework” and “bundles.” The OSGi framework provides an execution environment for electronically downloadable services, or bundles. The framework includes a runtime engine, life cycle management, data storage, version management and a service registry. Bundles are applications, including classes, methods and other resources, which provide functions, or “services,” to end-users of a computing system and to other bundles. Typically, bundles are stored in a Java Archive (JAR) file, which in turn is based upon the standard Zip file format.

Typically, a Java virtual machine (JVM) is a runtime engine that supports the Java programming language, which is a product of Sun Microsystems, Inc. of Santa Clara, Calif. The virtual machine executes programs that have been compiled into byte codes which are interpreted by the runtime environment rather then being compiled into native machine code. In this manner, a particular program can be written to execute on any hardware platform and suitable OS for which a JVM is available.

An OSGi framework is designed to operate in the runtime environment implemented by the JVM. The framework provides the core of the OSGi Service Platform Specification. As noted above, the OSGi Service Platform Specification was first developed to simplify the delivery of services over local networks and devices, industrial computers and automobiles. OSGi framework provides an execution environment for electronically downloadable services, or bundles. The framework includes program life cycle management, data storage, program version management and a service registry for bundles. Bundles are applications, including classes, methods and other resources, which provide functions, or “services,” to end-users of a wireless mobile device and other bundles.

OSGi bundles represent components that include classes and other resources which provide functions to end users of a system and to other bundles. Bundles typically implement zero or more services. Bundles can include such things as class files for the programming language as well as other data such as, but not limited to, hypertext markup language (HTML) files, help files and icons. OSGi compliant bundles can include a manifest file (not shown), which describes the contents of the corresponding bundle and provides information that the framework requires to correctly install and activate the corresponding bundle. Bundles a special class, or “bundle activator,” that provides methods to start and stop the bundle. In addition, bundles include information, in the manifest file, about any resource dependencies the corresponding bundle may have.

MIDlets represent Java applications (or a suite of closely-related applications) and are structured as archive (JAR) files. Typically, a MIDlet JAR file contains J2ME classes (code) and associated noncode resources. There have been proposals to encapsulate ring tones, screen savers and other resources. An OSGi bundle is also a JAR file. As to MIDlets, they typically include code, such as in the example of a motorcycle game, the code that is executed to create the game, along with data, such as images or bitmaps, and MIDlets may be digitally signed by a trusted authority so that a corresponding device that uses the MIDlet can perform suitable security operation such as verification of digitally signatures, as known in the art. The MIDlet code typically call MIDP API's and/or licensee closed classes (LCC). However, they do not typically include runtime services.

MIDlets are applications. They may include services necessary to execute the application or suite of applications contained within the MIDlet JAR file. However, MIDlets are disjoint: one MIDlet cannot define services that are used by another MIDlet. In contrast, OSGi bundles include for example code and data and services that are available at runtime to other OSGi bundles

Security within one version of OSGi is based upon the security model provided by the Java language, and an OSGi client is typically supported by an OSGi server. The OSGi server may simply provide new and updated bundles or may implement sophisticated device management. The protocol between the server and a handset for example is not specified by the OSGi standard. Many of today's enabled wireless mobile devices are predominantly based upon CLDC/MIDP, use a security model defined by MIDP, and are supported by over the air download MIDP servers that provision MIDlets. The network elements and also referred to as over the air servers, can provide interfaces by which consumers can purchase and download content with their wireless mobile devices. MIDP over the air servers are well known; and provision MIDlets. However, wireless handsets that employ OSGi bundles may require an operator for example to purchase additional OSGi servers in order for the operator to suitably communicate with and service the wireless mobile devices that employ OSGi bundles.

Accordingly, it would be desirable to utilize a conventional MIDP server to provision OSGi bundles so that an existing infrastructure can be used even though the wireless mobile devices may employ an OSGi framework in addition to, for example, a MIDP framework.

### BRIEF DESCRIPTION OF THE DRAWINGS

FIG. 1 is a schematic view illustrating an embodiment of a wireless communication system in accordance with the present invention.

FIG. 2 is a schematic view illustrating another embodiment of the wireless communication system in accordance with the present invention.

FIG. 3 is a block diagram illustrating exemplary internal components of various servers, controllers and devices that may utilize the present invention.

FIG. 4 is a block diagram representing the functional layers of a client device in accordance with the present invention.

FIG. 5 is a block diagram illustrating an embodiment of the functional layers of the client device in accordance with the present invention.

FIG. 6 is a block diagram illustrating another embodiment of the lower level functional layers of the client device in accordance with the present invention.

FIG. 7 is a block diagram illustrating one example of a system for providing OSGi bundles over the air in accordance with one embodiment of the invention.

FIG. 8 is a flow chart illustrating one example of a method for providing OSGi bundles in accordance with one embodiment of the invention.

FIG. 9 is a block diagram illustrating one example of a MIDlet wrapped OSGi bundle in accordance with one embodiment of the invention.

FIG. 10 is a flow chart illustrating one example of a method for processing an OSGi bundle in accordance with one embodiment of the invention.

### DETAILED DESCRIPTION OF THE PREFERRED EMBODIMENTS

Briefly, a method and apparatus for providing an open services gateway initiative (OSGi) bundle over the air to a wireless mobile device obtains data representing an OSGi bundle in the form of a JAVA archive (JAR) file, such as from a trusted authority, or any other suitable source, and generates, for sending to the wireless mobile device, a MIDlet wrapped OSGi bundle that contains data representing a MIDP JAR file containing the OSGi bundle and a corresponding MIDlet operative to invoke an OSGi bundle provisioning application interface (API) on the wireless mobile device to install the bundle. The method may be carried out for example by a network element, or any other suitable element or elements. In one example, a standard MIDP server sends the MIDlet wrapped OSGi bundle to the wireless mobile device since it is in suitable MIDP format although it contains an OSGi bundle. As such, conventional MIDP servers may be used to provision OSGi bundles and, among other things, alleviate a need to employ a separate OSGi server in a infrastructure. Other advantages will be recognized by those of ordinary skill in the art.

A wireless mobile device, that includes a wireless transceiver, and processor (i.e. one or more processing circuits), receives the MIDlet wrapped OSGi bundle and processes them by at least executing the corresponding MIDlet to invoke an OSGi bundle provisioning API on the wireless mobile device to install the bundle. In one embodiment, the processor is operative to automatically delete the corresponding MIDlet after it runs once. Also, in one embodiment, the corresponding MIDlet uses a device specific licensee closed class (LCC) API which passes a handle to the OSGi bundle. An underlying OSGi framework installs the bundle on the device.

As such the methods and system employs a MIDP provisioning path that is used to load OSGi management bundles. Typically, a MIDP server will contain a set of profiles that describe the characteristics of the models of devices it serves, such as the set of MIDP-defined APIs the device supports. For each model of device that uses OSGi bundles there will be a corresponding profile that represents the MIDP capabilities of that model, and the MIDP server will contain that profile. As such, this is not considered a change to the core MIDP server. Other advantages will be recognized by those of ordinary skill in the art.

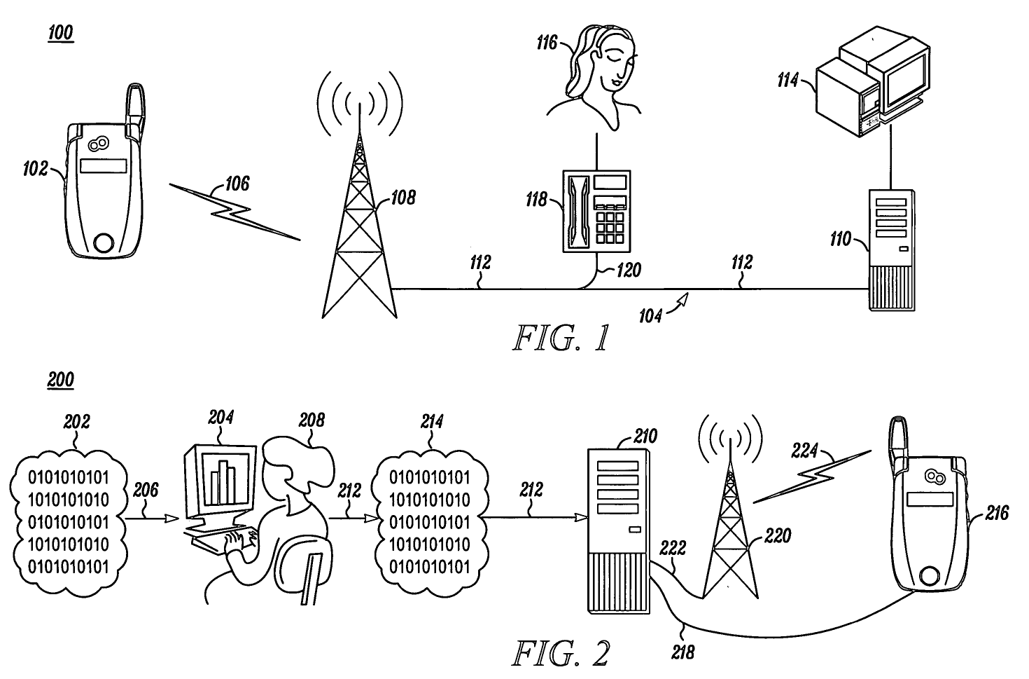

Referring to FIG. 1, there is provided a schematic view illustrating an embodiment of a wireless communication system 100. The wireless communication system 100 includes a wireless communication device 102 communicating with a wireless communication network 104 through a wireless link 106. Any type of wireless link 106 may be utilized for the present invention, but it is to be understood that a high speed wireless data connection is preferred. For example, the wireless communication network 104 may communicate with a plurality of wireless communication devices, including the wireless communication device 102, via a cellular-based communication infrastructure that utilizes a cellular-based communication protocols such as AMPS, CDMA, TDMA, GSM, iDEN, GPRS, EDGE, UMTS, WCDMA and their variants. The wireless communication network 104 may also communicate with the plurality of wireless communication devices via a peer-to-peer or ad hoc system utilizing appropriate communication protocols such as Bluetooth, IEEE 802.11, IEEE 802.16, and the like.

The wireless communication network 104 may include a variety of components for proper operation and communication with the wireless communication device 102. For example, for the cellular-based communication infrastructure shown in FIG. 1, the wireless communication network 104 includes at least one base station 108 and a server 110. Although a variety of components may be coupled between one or more base stations 108 and the server 110, the base station and server shown in FIG. 1 is connected by a single wired line 112 to simplify this example.

The server 110 is capable of providing services requested by the wireless communication device 102. For example, a user of the device 102 may send a request for assistance, in the form of a data signal (such as text messaging), to the wireless communication network 106, which directs the data signal to the server 110. In response, the server 110 may interrogate the device and/or network state and identify one or more solutions. For those solutions that require change or correction of a programmable module of the device 102, the server 110 may send update data to the device via the wireless link 106 so that the programmable module may be updated to fulfill the request. If multiple solutions are available, then the server 110 may send these options to the device 102 and await a response from the device before proceeding.

The wireless communication system 100 may also include an operator terminal 114, managed by a service person 116, which controls the server 110 and communicates with the device 102 through the server. When the server 110 receives the request for assistance, the service person may interrogate the device and/or network state to identify solution(s) and/or select the best solution if multiple solutions are available. The service person 116 may also correspond with the device 102 via data signals (such as text messaging) to explain any issues, solutions and/or other issues that may be of interest the user of the device.

The wireless communication system 100 may further include a voice communication device 118 connected to the rest of the wireless communication network 104 via a wired or wireless connection, such as wired line 118, and is available for use by the service person 116. The voice communication device 118 may also connect to the network via the server 110 or the operator terminal 114. Thus, in reference to the above examples, a user of the device 102 may send a request for assistance, in the form of a voice signal, to the wireless communication network 106, which directs the data signal to the server 110. While the server 110 and or the service person 116 is interrogating the device and/or network state, identifying one or more solutions, and/or selecting an appropriate solution, the service person may correspond with the device 102 via voice signals to explain any issues, solutions and/or other issues that may be of interest the user of the device.

Referring to FIG. 2, there is provided a schematic view illustrating another embodiment of the wireless communication system. For this embodiment, operator requirements 202 are received by a service terminal 204 via a first connection 206 and a service person 208 operates the service terminal 204, if necessary. For example, the service person 208 may provide information about a desired operator and/or needs of a device user so that the appropriate operator requirements 202 are received. The service terminal 204 may optionally be connected to a server 210 by a second connection 212. Regardless of whether the server 210 is used, the service terminal 204 generates appropriate components that should be sent to a wireless communication device 216 operated by the user in accordance with the operator requirements 202 and associated information. The device 216 may be coupled to the service terminal 204 or the server 210 via a wired connection 218, such as a cable or cradle connection to the device's external connector, or a wireless connection. The wireless connection may include a wireless communication network that includes a base station 220 connected to the service terminal 204 or the server 210 and a wireless link 224 communication with the device 216.

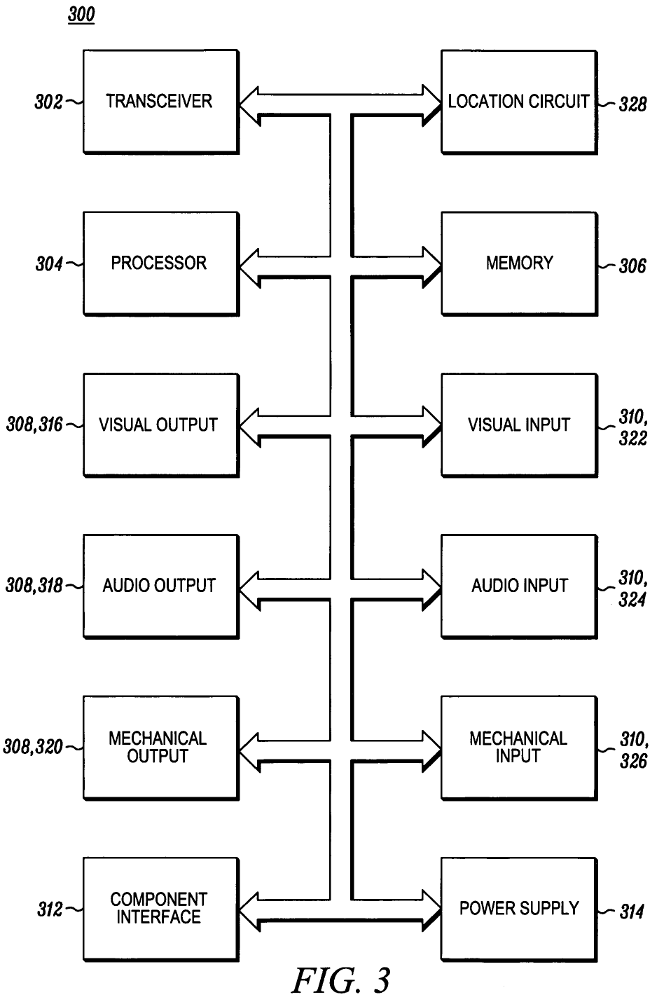

Referring to FIG. 3, there is provided a block diagram illustrating exemplary internal components of various servers, controllers and devices that may utilize the present invention, such as the wireless communication devices 102, 316 and the servers 110, 310 of FIGS. 1 and 2. The exemplary embodiment includes one or more transceivers 302, a processor 304, a memory portion 306, one or more output devices 308, and one or more input devices 310. Each embodiment may include a user interface that comprises at least one input device 310 and may include one or more output devices 308. Each transceiver 302 may be a wired transceiver, such as an Ethernet connection, or a wireless connection such as an RF transceiver. The internal components 300 may further include a component interface 312 to provide a direct connection to auxiliary components or accessories for additional or enhanced functionality. The internal components 300 preferably include a power supply 314, such as a battery, for providing power to the other internal components while enabling the server, controller and/or device to be portable.

Referring to the wireless communication devices 102, 316 and the servers 110, 310 of FIGS. 1 and 2, each machine may have a different set of internal components. Each server 110, 310 may include a transceiver 302, a processor 304, a memory 306 and a power supply 314 but may optionally include the other internal components 300 shown in FIG. 2. The memory 306 of the servers 110,310 should include high capacity storage in order to handle large volumes of media content. Each wireless communication device 102, 316 must include a transceiver 302, a processor 304, a memory 306, one or more output devices 308, one or more input devices 310 and a power supply 314. Due to the mobile nature of the wireless communication devices 102, 316, the transceiver 302 should be wireless and the power supply should be portable, such as a battery. The component interface 312 is an optional component of the wireless communication devices 102, 316.

The input and output devices 308, 310 of the internal components 300 may include a variety of visual, audio and/or mechanical outputs. For example, the output device(s) 308 may include a visual output device 316 such as a liquid crystal display and light emitting diode indicator, an audio output device 318 such as a speaker, alarm and/or buzzer, and/or a mechanical output device 320 such as a vibrating mechanism. Likewise, by example, the input devices 310 may include a visual input device 322 such as an optical sensor (for example, a camera), an audio input device 324 such as a microphone, and a mechanical input device 326 such as a flip sensor, keyboard, keypad, selection button, touch pad, touch screen, capacitive sensor, motion sensor, and switch.

The internal components 300 may include a location circuit 328. Examples of the location circuit 328 include, but are not limited to, a Global Positioning System (GPS) receiver, a triangulation receiver, an accelerometer, a gyroscope, or any other information collecting device that may identify a current location of the device.

The memory portion 306 of the internal components 300 may be used by the processor 304 to store and retrieve data. The data that may be stored by the memory portion 306 include, but is not limited to, operating systems, applications, and data. Each operating system includes executable code that controls basic functions of the communication device, such as interaction among the components of the internal components 300, communication with external devices via the transceiver 302 and/or the component interface 312, and storage and retrieval of applications and data to and from the memory portion 306. Each application includes executable code that utilizes an operating system to provide more specific functionality for the communication device, such as file system service and handling of protected and unprotected data stored in the memory portion 306. Data is non-executable code or information that may be referenced and/or manipulated by an operating system or application for performing functions of the communication device.

The processor 304 may perform various operations to store, manipulate and retrieve information in the memory portion 306. Each component of the internal components 300 is not limited to a single component but represents functions that may be performed by a single component or multiple cooperative components, such as a central processing unit operating in conjunction with a digital signal processor and one or more input/output processors. Likewise, two or more components of the internal components 300 may be combined or integrated so long as the functions of these components may be performed by the communication device.

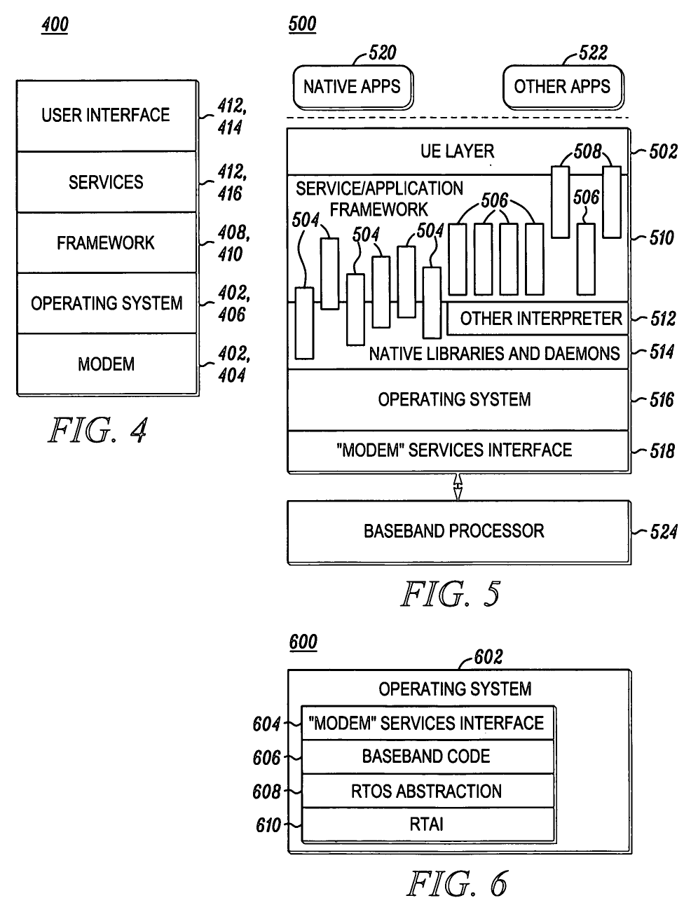

In accordance with the present invention, an expansion of known frameworks for more suitability to a wireless device operability is disclosed herein. FIG. 4, illustrates a basis architecture of a mobile device in accordance with the present invention. Existing known mobile devices are typically architected such that applications are loaded on top of a fixed base platform. APIs for applications are fixed at manufacture. Therefore it is not possible to postpone, for example, new media types and/or other upgrades. Turning to FIG. 4, a mobile device of the present invention utilizes an open OS, such as for example, Linux or Windows. Additionally, a modem interface is abstracted such that it is agnostic to the particular interface, for example radio interfaces such as GSM, CDMA, UMTS, etc. that would traditionally utilize dedicated functionality.

Referring to FIG. 4, there is provided a block diagram generally representing functional layers 400 included in the memory portion 306 (shown in FIG. 3) of a client device, such as the wireless communication device 102, 216. The functional layers 400 include low-level layers 402 including a modem layer 404 and an operating system layer 406, a mid-level layer 408 also known as a framework layer 410, and high-level layers 412 including a user interface layer 414 and a services layer 416. The modem layer 404 may be an abstracted interface to a modem circuit of the client device in which services are accessed through message passing. The modem layer 404 may be air-interface agnostic, i.e., may operate using a wide variety of air interface protocols. The modem layer 404 may also be an abstracted interface to an RTOS, and executive application programming interfaces (API's) may be encapsulated in a thin interface layer. Further, the modem code may be on a separate processor or co-resident with application code.

The operating system layer 406 operates above the modem layer 404 and provides basic platform services for the client device, such as process management, memory management, persistent storage (file system), Internet networking (TCP/IP), and native access security and application-to-application protection. The operating system layer 406 may expose native services based upon standards-defined API's (POSIX). The operating system layer 406 may host native applications, such as system daemons, specific-language interpreters (such as), and second-party native applications (such as a browser). Daemons are executable code that run as separate background processes and provide services to other executable code(s) or monitor conditions in the client device.

The framework layer 410 provides an operable interface between the low-level layers 402 and the high level layers 412 that provides ample opportunities for current and future functions and, yet, is efficient enough to avoid provide unnecessary code that may waste precious memory space and/or slow-down the processing power of the client device. Key features of the framework layer 410 may include, but are not limited to, hierarchical class loaders, application security, access to native services, and compilation technology for performance. Although the operating system layer 406 may host system daemons and specific-language interpreters, the framework layer 410 should actually include such system daemons and specific-language interpreters. The framework layer 410 may also include a framework for managing a variety of services and applications for the client device. For one embodiment, the framework layer 410 is an always-on CDC/FP/PBP JVM, OSGi framework.

The services layer 416 adapts the framework layer 410 to wireless communication services. The services layer 416 includes services packaged in modular units that are separately life-cycle managed (e.g., start, stop, suspend, pause, resume); are separately provisioned, upgraded and withdrawn; and abstracts the complexity of the service implementation from a user of the client device. Services are modular, extensible and postponeable so that, within the services layer 416, services may be added, upgraded and removed dynamically. In particular, the services layer 416 includes a lookup mechanism so that services may discover each other and applications may discover services used by other services, e.g., service provider interfaces (SPI's), and services used by applications, e.g., application programming interfaces (API's).

An API is a formalized set of function and/or method calls provided by a service for use by a client device, whereas an SPI is a set of interfaces and/or methods implemented by a delegated object (also called provider) providing an API to the client device. If an API is offering methods to client devices, more API's may be added. Extending the functionality to offer more functionality to client devices will not hurt them. The client device will not use API's that are not needed. On the other hand, the same is not true for SPI's. For SPI's, the addition of a new method into an interface that others must provide effectively breaks all existing implementations.

The user interface layer 414 manages applications and the user interface for the client device. The user interface layer 414 includes lightweight applications for coordinating user interaction among the underlying services of the services layer 416. Also, the user interface layer 414 is capable of managing native applications and language-specific application, such as (possibly) a dialer for phone calls. (Many types of language-specific applications are possible.) The user interface layer 414 creates a unifying environment for the native applications and the language-specific applications so that both types of applications have a similar “look and feel”. The native applications utilize components of a native toolkit, and the language-specific applications utilized components of a corresponding language-specific toolkit. For the user interface layer 414, a language-specific user interface toolkit is built on the native toolkit, and MIDlets are mapped to the language-specific user interface toolkit.

FIG. 5 illustrates details of a mobile device architecture, having dual processors, in accordance with some embodiments of the present invention. In FIG. 5 a Service/Application Framework provides services such as but not limited to; messaging, security, DRM, device management, persistence, synchronization, and power management. An abstracted modem service interface communicates with the baseband processor, wherein the baseband processor may communicate over any suitable radio interface. In FIG. 5, the UE Layer, may be implemented for example in. The Operating System is an open operating system and may utilize for example Linux or Windows.

Unlike prior art architectures, as previously mentioned, wherein applications are loaded on top of a fixed base platform, applications as shown in the embodiments illustrated by FIG. 5 are architected in a more flexible structure. In accordance with the embodiments of FIG. 5, application and feature upgrades, new content types, new standards-based upgrades, new operator specific service libraries, and component upgrade and repair are facilitated.

Referring to FIG. 5, there is provided a block diagram illustrating a first client embodiment 500 included in the memory portion 306 of the client device, such as the wireless communication device 102, 216. The first client embodiment 500 includes a UE layer 502, a plurality of services 504, 506, 508, a service/application framework 510, an other or language-specific interpreter 512 (such as Virtual Machine), native libraries and daemons 514, an operating system 516, and a modem services interface 518. The UE layer 502 interacts with native applications 520 and language-specific applications 522, such as (for example) a dialer for phone calls. The modem services interface interacts 518 with a baseband processor 524 of the client device.

The applications are user-initiated executable code whose lifecycle (start, stop, suspend, pause, resume) may be managed. The applications may present a User Interface and/or may use services. Each daemon is an operating system (OS) initiated, executable code that runs as a separate background process. Daemons may provide services to other executable code or monitor conditions in the client.

There is organizational cooperation of the services 504, 506, 508 with the mid-level layer 408 which includes the service/application framework 510, the language-specific interpreter 512 and the native libraries and daemons 514 as well as the UE layer 502. As represented by FIG. 5, the types of available services include native-based services 504 which rely on one or more components of the native libraries and daemons 514, language-specific services 506 which rely on components associated with the language-specific interpreter 512, and native or language-specific services 508 that further rely on components of the UE layer 502.

A service is a set of functionality exposed via a well-defined API and shared among applications. A service has as least two characteristics, namely a service interface and a service object. The service interface is the specification of the service's public methods. The service object implements the service interface and provides the functionality described in the interface. A service may provide methods that present a User Interface. Invoking a method on a service is done in the caller's context (thread/stack). Services may return a value to the requesting client by depositing it on the caller's stack, unlike an invoked application. The implementation of the service may be replaced without affecting its interface Examples of services include, but are not limited to, messaging, security, digital rights management (DRM), device management, persistence, synchronization and power management.

A system service is a low-level service specific to an operating system or MA and is not part of the abstract set of services exposed to platform components. System service APIs should not be used by any component that is intended to portable across all instantiations of the platform. A framework service is a service that exposes a higher level extraction over system services and provides OS-independent and MA-independent access to infrastructure components and services. An application service is a service that exposes application-specific functionality (both UI and non-UI) via a well defined API. A native service is a service written in native code.

A library is a set of services contained in an object that can either be statically linked or dynamically loaded into executable code. Library services may invoke other library services or services contained in daemons, which are external to the library and may also run in a different process context.

Referring to FIG. 6, there is provided a block diagram illustrating a second client embodiment 600 of the lower level functional layers of the client device. The first client embodiment 500 represents a dual processor architecture of a client device, whereas the second client embodiment 600 represents a single core architecture of a client device. For the second client embodiment 600, the operating system 602 includes the modem services interface 604 and a baseband code 606. In addition, the operating system 602 may include other components, such as an RTOS abstraction 608 and an RTAI 610.

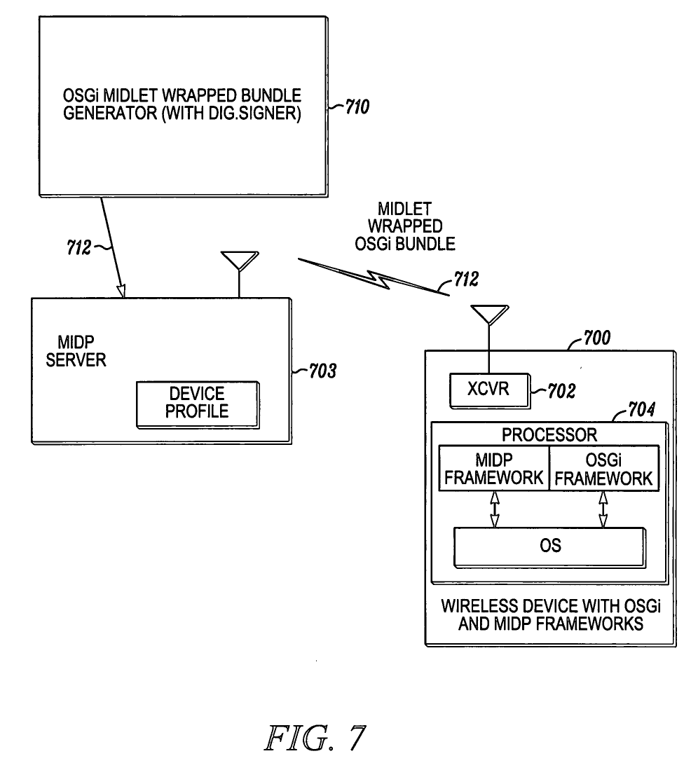

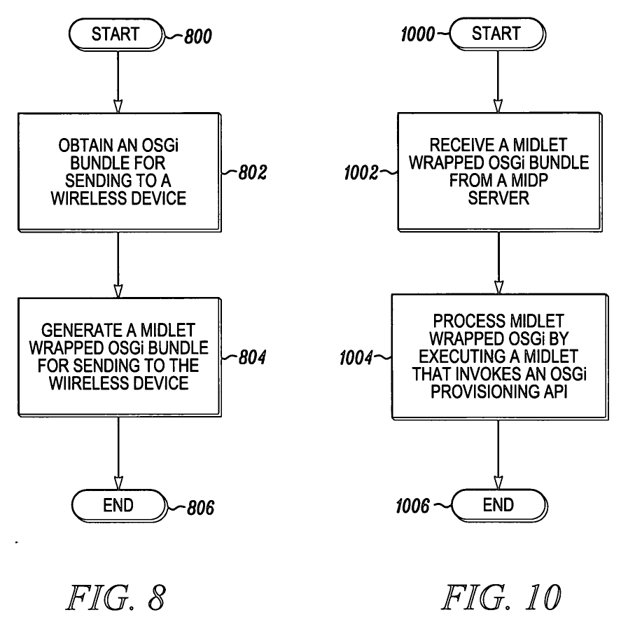

FIG. 7 is a block diagram of one example of a communications system that employs a wireless communication device such as a wireless mobile device 700 that includes suitable memory 306 for storing application code and operating system code in the form of executable instructions that when executed by one or more processors performs the functions as described herein. The wireless mobile device 700 includes a conventional wireless transceiver 702 for wirelessly sending and receiving information to another wireless device or network element 103 either directly or through a suitable network as described earlier. In addition, the wireless mobile device includes a processor 704 which may be any suitable structure (including multiple processors) which is suitably programmed to carry out the operations described below.

For example, the processor 704 may include numerous software modules stored in memory which cause the processor to operate as described below. As shown, the processor may employ an operating system 516 such as a Linux operating system or any other suitable operating system, and platform code 510 which may include a Java virtual machine (JVM) which as known in the art runs desired Java components. The platform described in this particular example includes a Java 2 security model and corresponding Java 2 security manager.

The wireless mobile device 700 in this example provides two different execution environments, an OSGi execution environment and a MIDlet execution environment. OSGi-based components contained in OSGi bundles have associated Java 2 permissions whereas MIDlets 710 have their own associated MIDP permissions.

The processor 704 also employs Java API's, one or more shared API's which as used here also includes sets of shared API's, such as JSR's, and MIDP API's 716 that are used by MIDlet applications. Similarly, the Java API 's are used in conjunction with the Java applications. The platform code 510 includes in this example the Java virtual machine (JVM) 720, and also includes a MIDP runner. The MIDP runner is code that complies with the Java 2 security model and which serves as an emulator of a MIDP environment. However, it will be recognized that any suitable implementation may be used including separate MIDP and OSGi environments.

JSR implementations such as JSR 120, JSR 135 and others are typically available to MIDlets. Using these API's, MIDlets, for example, can send or receive SMS messages. JSR's are also available to OSGi-based applications and services and as such are shared API's.

The network element 703 may be for example a conventional MIDP server that includes a plurality of device profiles describing the MIDP characteristics of the device models it serves. The system may also include for example a MIDlet wrapped OSGi bundle generator 710 that may be included within the MIDP server if desired or may be another server that is in communication with the MIDP server. The MIDlet wrapped OSGi bundle generator 710 may be implemented as a processor (i.e., multiple processors) executing a suitable program that obtains the OSGi bundle and generates a MIDlet wrapped OSGi bundle 712 for sending to the wireless mobile device 700 by the network element 703 or in any other suitable manner. The network element 703 is shown functionally to include a suitable wireless transceiver and antenna, however it will be recognized that these functions may be distributed throughout a suitable network infrastructure as desired. The MIDlet wrapped OSGi bundle generator 710 may also include a digital signing algorithm that digitally signs any generated MIDlet wrapped OSGi bundles and as such may act as a trusted authority. In operation, the wireless mobile device 700 receives the MIDlet wrapped OSGi bundle 712 and verifies the digital signature (if it exists) to determine whether it can trust the MIDlet wrapped OSGi bundle. If so, the MIDlet wrapped OSGi bundle is processed.

The MIDP server 703 may be implemented in any suitable manner including through a suitably programmed processor and associated memory and may be accessible via the Internet or any other suitable network and may be in suitable communication with wireless over the air interfaces to facilitate over the air provisioning of the MIDlet wrapped OSGi bundle 712. The MIDlet wrapped OSGi bundle 712 is treated as a conventional MIDP file by the MIDP server and as such the MIDP server 703 may be implemented as a standard MIDP download server that includes, for example, the OSGi profile.

The MIDlet wrapped OSGi bundle generator is functionally distinct from the MIDP download server. This function may be performed at a separate time and possibly hosted on a separate processor and memory. Alternatively, this function could be co-located with the MIDP download server (hosted on the same processor and memory system), and it could be performed either in advance of download or upon demand. The processor of the MIDlet wrapped OSGi bundle generator is operative to generate the MIDlet wrapped OSGi bundle 712 in advance of being requested for sending to the wireless mobile device (e.g., by a service operator or the wireless device) or on demand for the wireless mobile device (e.g., by a service operator or by the wireless device).

FIG. 8 illustrates one example of a method for providing an open services gateway initiative (OSGi) bundle over the air to a wireless mobile device. The method may be carried out by any suitable combination of structure and in this example are operations carried out by the MIDlet wrapped OSGi bundle generator 710. As shown, the method includes obtaining, as shown in block 802, an OSGi bundle, such as from any suitable source (including, but not limited to, a software developer, wireless operator, or wireless device manufacturer) for sending to a wireless device such as wireless device 700. The OSGi bundle may be obtained for example from a wireless device manufacturer, to add or upgrade a software capability of the device. However, it will be recognized that the OSGi bundle may be created by any suitable source including the generator 710. As such, an OSGi bundle includes data that represents, for example, executable code and data used by the executable code in the form of a Java archive file.

As shown in block 804, the method includes generating, for sending to the wireless mobile device 700, the MIDlet wrapped OSGi bundle 712 which contains data representing a MIDP JAR file that contains the OSGi bundle (in the form of the JAR file) and as such is a JAR within a JAR configuration. The MIDlet wrapped OSGi bundle also includes a corresponding MIDlet that is operative to invoke an OSGi bundle provisioning application interface located on the wireless mobile device 700. The method then ends at block 806, by for example the MID let wrapped OSGi bundle generator 710 sending the created MIDlet wrapped OSGi bundle 712 to the network element 703 such as a MIDP server.

Stated another way, the OSGi bundle is encapsulated within a MIDP JAR file. From a MIDP standpoint, the MIDlet wrapped OSGi bundle is a compliant MIDlet that can be provisioned to the wireless mobile device by any compliant over the air server.

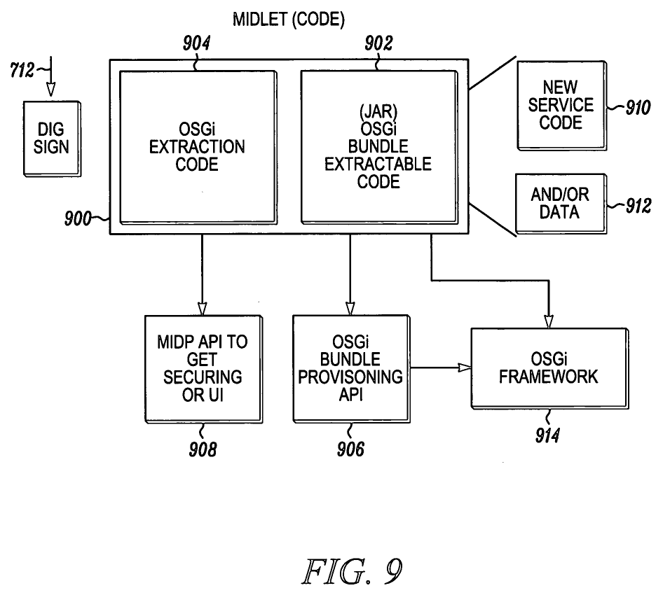

FIG. 9 illustrates diagrammatically the data included to form one example of a MIDlet wrapped OSGi bundle 712. As shown, the MIDlet wrapped OSGi bundle 712 may include data representing an outer MIDP JAR file 900 containing the OSGi bundle 902 in the form of an inner JAR file and a corresponding MIDlet 904, in the form of Java executable files (e.g., a Java class file) contained within the outer JAR file. The MIDlet is operative to serve as OSGi abstraction code by for example invoking an OSGi bundle provisioning application interface 906 on the wireless mobile device 700. In addition, the MIDlet 904 may also include or invoke MIDP API's 908 to obtain other resources. The wireless device implements an LCC within the MIDP environment that provides access to the underlying OSGi bundle manager. Preferably, although not required, access to this LCC is restricted, for example, using MIDP 2 security model to MIDlets signed for example by a given provider. The LCC provides operations to install, update and remove bundles. In addition an LCC can be used to allow the MIDlet to delete itself upon termination.

The OSGi bundle 902 may include for example service code 910 and/or associated data 912 used by the service code, as known in the art. The OSGi bundle 902 and the OSGi bundle provisioning API are accessed by the OSGi framework functionally as shown as 914.

FIG. 10 illustrates one example of a method for processing the MIDlet wrapped OSGi bundle 712 in accordance with one embodiment of the invention. As shown in block 1000, the method begins by, for example, the wireless device entering a MIDP provisioning mode and as shown in block 1002 may include receiving, by the wireless mobile device, the MIDlet wrapped OSGi bundle 712 and processing the MIDlet wrapped OSGi bundle 712 by at least executing the OSGi bundle provisioning API 906. This is shown in block 1004. The process may then end as shown in block 106 which may include for example the MIDlet 904 being automatically deleted from memory of the wireless mobile device to save memory space.

As such, after being loaded, the MIDlet 904 is executed. It invokes the bundle management LCC passing a reference to the OSGi bundle 902 encapsulated within the MIDlet 904. Upon successful installation of the bundle 902, the MIDlet 904 terminates and deletes itself. A similar mechanism can be used to update a bundle or to remove a bundle. Bundles can be pulled by the user or pushed (e.g., via WAP push) using the same mechanisms as the MIDlet pull/push.

As noted above, the MIDlet 904 serves OSGi extraction code and is operative to cause the calling of at least the MIDP API 908 (where present) and OSGi bundle provisioning API 906. The operation as shown for example in FIG. 10 may be carried by the processor of the wireless mobile device, or any other suitable structure.

By encapsulating the OSGi bundle within a MIDP JAR file, a MIDP server can be used to provision OSGi bundles so that a separate OSGi server need not be utilized to provision OSGi bundles. Other advantages will be recognized by those of ordinary skill in the art.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for providing an open services gateway initiative (OSGi) bundle over the air to a wireless mobile device comprising:
obtaining data representing an OSGi bundle in the form of a Java Archive (JAR) file; and
generating, for sending to the wireless mobile device, a MIDlet wrapped OSGi bundle containing data representing a MIDP JAR file containing the OSGi bundle in the form of the JAR file and a corresponding MIDlet operative to invoke an OSGi bundle provisioning application interface (API) on the wireless mobile device to install said bundle.

2. The method of claim 1 wherein the corresponding MIDlet of the MIDlet wrapped OSGi bundle includes data representing at least: OSGi extraction code that is operative to cause calling of at least one MIDP API and wherein the OSGi bundle includes code representing a service available in the wireless mobile device.

3. The method of claim 1 including sending to the wireless mobile device, the MIDlet wrapped OSGi bundle containing data representing a MIDP JAR file containing the OSGi bundle in the form of the JAR file and a corresponding MIDlet operative to invoke an OSGi bundle provisioning application interface (API) to install said bundle.

4. The method of claim 3 including digitally signing the MIDlet wrapped OSGi bundle.

5. A method for processing an open services gateway initiative (OSGi) bundle in a wireless mobile device comprising:
receiving, by the wireless mobile device, a MIDlet wrapped OSGi bundle containing data representing a MIDP JAR file containing the OSGi bundle in the form of the JAR file and a corresponding MIDlet operative to invoke an OSGi bundle provisioning application interface (API) on the wireless mobile device to install said bundle; and
processing the MIDlet wrapped OSGi bundle by at least executing the corresponding MIDlet to invoke an OSGi bundle provisioning API to install said bundle.

6. The method of claim 1 including verifying a digital signature of the MIDlet wrapped OSGi bundle to determine if the MIDlet wrapped OSGi bundle can be trusted by the wireless mobile device.

7 A network element comprising:
a MIDP server operative to send a MIDlet wrapped OSGi bundle containing data representing a MIDP JAR file containing the OSGi bundle in the form of the JAR file and a corresponding MIDlet operative to invoke an OSGi bundle provisioning application interface (API) on the wireless mobile device to install said bundle.

8. A wireless mobile device comprising:
a wireless transceiver; and
a processor operatively coupled to the wireless transceiver and operative to execute code representing a MIDlet wrapped OSGi bundle containing data representing a MIDP JAR file containing the OSGi bundle in the form of the JAR file and a corresponding MIDlet operative to invoke an OSGi bundle provisioning application interface (API) on the wireless mobile device and operative to process the MIDlet wrapped OSGi bundle by executing the current ending MIDlet to invoke an OSGi bundle provisioning API to install said bundle.

9. The wireless mobile device of claim 8 including memory operatively coupled to the processor and containing the MIDlet wrapped OSGi bundle.

10. The wireless mobile device of claim 8 wherein the processor is operative to delete the corresponding MIDlet it executes.

11. An apparatus for providing an open services gateway initiative (OSGi) bundle over the air to a wireless mobile device comprising:
a processor; and
memory containing executable instruction that when executed by the processor, cause the processor to:
obtain data representing an OSGi bundle in the form of a Java Archive (JAR) file; and
generate, for sending to the wireless mobile device, a MIDlet wrapped OSGi bundle containing data representing a MIDP JAR file containing the OSGi bundle in the form of the JAR file and a corresponding MIDlet operative to invoke an OSGi bundle provisioning application interface (API) on the wireless mobile device to install said bundle.

12. The apparatus of claim 11 including memory containing executable instructions that also cause the processor to send to the wireless mobile device, the MIDlet wrapped OSGi bundle containing data representing a MIDP JAR file containing the OSGi bundle in the form of the JAR file and a corresponding MIDlet operative to invoke an OSGi bundle provisioning application interface (API) to install said bundle.

13. The apparatus of claim 11 wherein the processor is operative to generate the MIDlet wrapped OSGi bundle in advance of being requested for sending to the wireless mobile device or on demand for the wireless mobile device.
